(19) United States
(12) Patent Application Publication
(10) Pub. No.: US 2019/0029047 A1
(43) Pub. Date: Jan. 24, 2019

(54) CHANNEL DETECTION METHOD, CHANNEL DETECTION DEVICE, AND TERMINAL

(71) Applicant: YULONG COMPUTER TELECOMMUNICATION SCIENTIFIC (SHENZHEN) CO., LTD., Shenzhen (CN)

(72) Inventors: YA-JUN ZHU, Shenzhen (CN); MING-JU LI, Shenzhen (CN); YUN-FEI ZHANG, Shenzhen (CN)

(21) Appl. No.: 16/071,493

(22) PCT Filed: Sep. 28, 2016
(86) PCT No.: PCT/CN2016/100547

§ 371 Date: Jul. 20, 2018

(30) Foreign Application Priority Data
Jan. 21, 2016 (CN) 201610040303.5

(51) Int. Cl. H04W 74/08; H04W 16/14; H04W 74/00

(52) U.S. Cl. CPC H04W 74/0816; H04W 74/006; H04W 16/14

(57) ABSTRACT

The present disclosure provides a channel detection method of a Long Term Evolution (LTE) system in an unlicensed frequency band, a channel detection device, and a terminal, wherein the channel detection method of the LTE system in an unlicensed frequency band includes: receiving indication information sent by a base station; performing an uplink channel detection in an unlicensed frequency band based on the indication information; and sending uplink data when the uplink channel is detected to be in an idle state. The technical solution of the present disclosure enables the terminal to perform a reasonable channel detection process, on the premise that the frequency spectrum utilization efficiency is improved, the coexistence with other systems in the unlicensed frequency band is realized, and thereby ensure the fairness of competing channels in the unlicensed frequency band at the same time.

### CROSS-REFERENCE TO RELATED APPLICATIONS

This application claims priority of Chinese Patent Application No. 201610040303.5, entitled “channel detection method, channel detection device, and terminal,” filed on Jan. 21, 2016 in the SIPO (State Intellectual Property Office of the People's Republic of China), the entire contents of which are incorporated by reference herein.

### FIELD

The embodiments of the present disclosure relates to a technical field of communication, specifically a channel detection method of a Long Term Evolution (LTE) system in an unlicensed frequency band, a channel detection device for the LTE system in the unlicensed frequency band, and a terminal.

### BACKGROUND

At present, with rapid development of mobile services, capacity of existing wireless frequency spectrums allocated to the mobile service cannot meet requirements. In the 3GPP Rel-13 phase, a mechanism called Licensed-Assisted Access (LAA) is introduced. In the LAA mechanism, transmission of mobile communication can be performed on unlicensed frequency spectrums, such as 5 GHz frequency bands. Currently, the unlicensed frequency spectrums are mainly used by WI-FI™, BLUETOOTH™, radar, medical systems, etc.

In an LAA system, in order to ensure fair sharing of unlicensed frequency spectrums with other systems, a mechanism of Listening Before Talk (LBT) is introduced. That is to say, before sending data, a sending end is required to detect whether a channel is idle, the data can be sent only when the channel is idle. Currently, there are two mechanisms for LBT, one is the LBT mechanism based on Frame-Based Equipment (FBE), and the other is the LBT mechanism based on Load-Based Equipment (LBE). In the LBT mechanism based on FBE, it is needed to detect whether the channel is idle according to a preset period; in the LBT mechanism based on LBE, it can be initiated to detect whether the channel is idle at any time according to service requirements. Operations of the LBT are based on an energy detection, that is, when a signal strength on the channel is found to be lower than a certain threshold value during continuous channel monitoring, the channel is considered to be idle.

For a downlink transmission, a base station side only needs to perform LBT operations, and when it is detected that the channel is in an idle state, a base station can send downlink data to a terminal, the terminal side does not need to identify whether the channel is idle or not.

For an uplink transmission, the uplink transmission is controlled by the base station due to design of the LTE system. That is, the base station needs to send an uplink scheduling instruction to the terminal, the terminal can transmit data at a corresponding position based on an indication of the uplink scheduling instruction. In the design, the design of the transmission of the terminal on the unlicensed frequency spectrums can have a plurality of implementation methods. In case of self-scheduling, the scheduling instruction of the uplink transmission on an unlicensed frequency spectrum is sent from the unlicensed frequency spectrum, as shown in FIG. 1A. A subframe n of the base station on the unlicensed frequency spectrum sends an uplink scheduling instruction to the terminal, indicating that the subframe n+4 of the terminal on the unlicensed frequency spectrum can transmit uplink data. Under a condition of cross-carrier scheduling, the scheduling instruction of uplink transmission on the unlicensed frequency spectrum can be sent from the licensed frequency spectrum, as shown in FIG. 1B. The subframe n of the base station on the licensed frequency spectrum sends an uplink scheduling instruction to the terminal,. indicating that the subframe n+4 of the terminal on the unlicensed frequency spectrum can transmit uplink data.

At present, in a process of standardization of LAA, for a design of LBT for an uplink transmission, the following schemes are considered:

Scheme 1: the terminal performs a one-shot LBT before the uplink transmission, if the channel is idle, the channel can be accessed for the uplink transmission;

Scheme 2: the terminal makes an LBT based on LBE before the uplink transmission;

Scheme 3: an LBT is only made on the base station side, and the uplink transmission is directly sent within a certain time after the channel is occupied and the downlink transmission ends.

However, all of the above schemes have corresponding problems. Specifically, the above scheme 1 can influence the coexistence of other systems in the unlicensed frequency band, as in the scheme 1 a channel is easy to occupy, the problem of incapability of fair coexistence can be caused when the system is in coexistence with the other systems; in the case of the scheme 2, as channel environments of different terminals are different, which may result in the problem that the terminal cannot transmit through the multiplexing channel, and the frequency spectrum efficiency can fall; in the case of the scheme 3, as the terminal does not do an LBT before the terminal side performs the uplink transmission, thus the coexistence of the terminal and the other systems can be influenced.

### SUMMARY

The present disclosure is based on at least one of the above technical problems, and provides a channel detection solution of a new LTE system when the new LTE system works in an unlicensed frequency band, thus the terminal can perform a reasonable channel detection process, and on the premise that the frequency spectrum utilization efficiency is improved, the coexistence with other systems in an unlicensed frequency band is realized, and thereby ensuring the fairness of competing channels in an unlicensed frequency band at the same time.

In view of the above, according to a first aspect of the present disclosure, a channel detection method of an LTE system in an unlicensed frequency band is provided, which includes: receiving indication information sent by a base station; performing an uplink channel detection in an unlicensed frequency band based on the indication information; sending uplink data when the uplink channel is detected to be in an idle state.

In the technical solution, the uplink channel detection is performed in the unlicensed frequency band according to the indication information sent by the base station, thus, when the base station instructs the terminal to perform the channel detection, a situation of uplink multi-user multiplexing can be considered, and the terminal can be further instructed to perform a reasonable channel detection process. Moreover, on the premise that the frequency spectrum utilization efficiency is improved, the coexistence with other systems (such as a WI-FI system) is realized in an unlicensed frequency band, thereby ensuring the fairness of competing channels in an unlicensed frequency band at the same time.

In the above technical solution, optionally, the step of receiving indication information sent by the base station, and specifically includes: receiving parameter information of a channel detection performed by the terminal sent by the base station;

The step of performing the uplink channel detection in an unlicensed frequency band based on the indication information, and specifically includes: according to the parameter information, determining a position of a subframe that can be used for an uplink transmission, and monitoring an uplink scheduling instruction sent by the base station at the corresponding position of the subframe, when the uplink scheduling instruction is monitored, performing the uplink channel detection according to the parameter information.

In the technical solution, the base station can notify the terminal of the parameter information of the channel detection performed by the terminal in advance, the terminal determines the position of the subframe which can be used for uplink transmission according to the parameter information, and then the terminal can monitor whether the uplink scheduling instruction is sent by the base station at the corresponding position. When the uplink scheduling instruction is monitored, the terminal can perform the uplink channel detection according to the parameter information notified by the base station in advance. Specifically, after the base station notifies the terminal of the parameter information of performing the channel detection, the terminal considers that the subframe n+4 can be the position of the subframe, which can be used for uplink transmission based on the parameter information notified by the base station, it is further determined that the uplink scheduling instruction can be sent on the subframe n, and the terminal can monitor whether the uplink scheduling instruction sent by the base station is received on the subframe n, when received, the uplink channel detection can be performed on a subframe n+3.

In the above technical solution, optionally, the parameter information includes a combination of any one or more of the following: the position of the subframe that can be used for the uplink channel detection performed by the terminal, a symbol position that can be used for the uplink channel detection performed by the terminal, a period that can be used for the uplink channel detection performed by the terminal, and a Clear Channel Assessment (CCA) threshold value that can be used for the uplink channel detection performed by the terminal.

In any of the above technical solutions, optionally, the symbol position that can be used for the uplink channel detection performed by the terminal is fixed, the symbol position can be last one or more symbols of the subframe, or one or more symbols at the beginning of the subframe.

In any of the above technical solutions, optionally, the method further includes: monitoring the uplink scheduling instruction sent by the base station in a licensed frequency band and/or the unlicensed frequency band.

In any of the above technical solutions, optionally, the step of receiving the indication information sent by the base station specifically includes: monitoring the uplink scheduling instruction sent by the base station; and the step of performing the uplink channel detection in the unlicensed frequency band based on the indication information specifically includes: when the uplink scheduling instruction sent by the base station is monitored on any subframe, performing the uplink channel detection on a position corresponding to the any subframe.

In the technical solution, the base station does not need to notify the terminal of related information in advance, the terminal can continuously monitor the unlicensed frequency band or the licensed frequency band, to determine whether the uplink scheduling instruction sent by the base station is monitored. When the uplink scheduling instruction sent by the base station is monitored on any subframe, the terminal can perform the uplink channel detection on a corresponding position in the unlicensed frequency band. Specifically, if the terminal monitors the uplink scheduling instruction sent by the base station on the subframe n, the uplink scheduling instruction instructs the terminal to perform the uplink transmission on the subframe n+4, the terminal can perform the uplink channel detection on the subframe n+3.

In the above technical solution, optionally, the method further includes: determining a position corresponding to the any subframe based on a predefined rule, or

Receiving notification information sent by the base station, and determining the position corresponding to the any subframe according to the notification information.

In any of the above technical solutions, optionally, the step of receiving the indication information sent by the base station specifically includes: receiving an adjustment rule of the channel detection parameters sent by the base station;

The step of performing the uplink channel detection in the unlicensed frequency band based on the indication information specifically includes: adjusting the parameters of the terminal for performing the uplink channel detection every time according to the adjustment rule, and performing the uplink channel detection based on the adjusted parameters.

In the technical solution, the base station can notify the adjustment rule of the uplink channel detection parameters of the terminal, and then the terminal can adjust the channel detection parameters every time when the uplink channel detection is performed. For example, when the channel detection is performed every time, the threshold value of the channel detection can be adjusted every time.

In the above technical solution, optionally, the channel detection parameters include a combination of any one or more of the following: the CCA threshold value, the position of the subframe that can be used for the channel detection, the symbol position that can be used for the channel detection.

In any of the above technical solutions, optionally, the step of receiving the indication information sent by the base station specifically includes: receiving the indication information sent by the base station in the licensed frequency band or the unlicensed frequency band through wireless resource control signaling, media access control unit signaling or physical layer signaling.

According to a second aspect of the present disclosure, the present disclosure further provides a channel detection device of the LTE system in an unlicensed frequency band, which includes: a receiving unit configured to receive indication information sent by the base station; a channel detection unit configured to perform the uplink channel detection in the unlicensed frequency band based on the indication information; and a sending unit configured to send uplink data when the uplink channel is detected to be in the idle state by the channel detection unit.

In the technical solution, the uplink channel detection is performed in the unlicensed frequency band according to the indication information sent by the base station, thus, when the base station instructs the terminal to perform the channel detection, the situation of uplink multi-user multiplexing can be considered, and the terminal can be further instructed to perform the reasonable channel detection process. Moreover, on the premise that the frequency spectrum utilization efficiency is improved, the coexistence with other systems (such as the WI-FI system) is realized in the unlicensed frequency band, thereby ensuring fairness between competing channels in the unlicensed frequency band at the same time.

In the above technical solution, optionally, the receiving unit is specifically configured to: receive parameter information of the channel detection performed by the terminal sent by the base station; the channel detection unit is specifically configured to: according to the parameter information, determine the position of the subframe which can be used for the uplink transmission, and monitor the uplink scheduling instruction sent by the base station at the corresponding position of the subframe, when the uplink scheduling instruction is monitored, perform the uplink channel detection according to the parameter information.

In the technical solution, the base station can notify the terminal of the parameter information of the channel detection performed by the terminal in advance, the terminal determines the position of the subframe which can be used for uplink transmission according to the parameter information, and then the terminal can monitor whether the uplink scheduling instruction is sent by the base station at the corresponding position. When the uplink scheduling instruction is monitored, the terminal can perform the uplink channel detection according to the parameter information notified by the base station in advance. Specifically, after the base station notifies the terminal of the parameter information of performing the channel detection, the terminal considers that the subframe n+4 can be the position of the subframe, which can be used for uplink transmission based on the parameter information notified by the base station, it is further determined that the uplink scheduling instruction can be sent on the subframe n, and the terminal can monitor whether the uplink scheduling instruction sent by the base station is received on the subframe n, when received, the uplink channel detection can be performed on the subframe n+3.

In the above technical solution, optionally, the parameter information includes the combination of any one or more of the following: the position of the subframe that can be used for the uplink channel detection performed by the terminal, the symbol position that can be used for the uplink channel detection performed by the terminal, the period that can be used for the uplink channel detection performed by the terminal, and the CCA threshold value that can be used for the uplink channel detection performed by the terminal.

In any of the above technical solutions, optionally, the channel detection unit monitors the uplink scheduling instruction sent by the base station in the licensed frequency band and/or the unlicensed frequency band.

In any of the above technical solutions, optionally, the receiving unit is specifically configured to: monitor the uplink scheduling instruction sent by the base station; the channel detection unit is specifically configured to: when the uplink scheduling instruction sent by the base station is monitored by the receiving unit on any subframe, perform the uplink channel detection on the position corresponding to the any subframe.

In the technical solution, the base station does not need to notify the terminal of related information in advance, the terminal can continuously monitor the unlicensed frequency band or the licensed frequency band, to determine whether the uplink scheduling instruction sent by the base station is monitored. When the uplink scheduling instruction sent by the base station is monitored on any subframe, the terminal can perform the uplink channel detection on the corresponding position in the unlicensed frequency band. Specifically, if the terminal monitors the uplink scheduling instruction sent by the base station on the subframe n, the uplink scheduling instruction instructs the terminal to perform the uplink transmission on the subframe n+4, the terminal can perform the uplink channel detection on the subframe n+3.

In the above technical solution, optionally, the device further includes: a first determining unit configured to determine the position corresponding to the any subframe based on the predefined rule; or a second determining unit configured to receive the notification information sent by the base station, and determine the position corresponding to the any subframe according to the notification information.

In any of the above technical solutions, optionally, the receiving unit is specifically configured to: receive the adjustment rule of the channel detection parameters sent by the base station; the channel detection unit is specifically configured to: adjust the parameters of the terminal for performing the uplink channel detection every time according to the adjustment rule, and perform the uplink channel detection based on the adjusted parameters.

In the technical solution, the base station can notify the adjustment rule of the uplink channel detection parameters of the terminal, and then the terminal can adjust the channel detection parameters every time the uplink channel detection is performed. For example, when the channel detection is performed every time, the threshold value of the channel detection can be adjusted every time.

In the above technical solution, optionally, the channel detection parameters include a combination of any one or more of the following: the CCA threshold value, the position of the subframe that can be used for the channel detection, the symbol position that can be used for the channel detection, and the period that can be used for the channel detection.

In any of the above technical solutions, optionally, the receiving unit is specifically configured to: receive the indication information sent by the base station in the licensed frequency band or the unlicensed frequency band through wireless resource control signaling, media access control unit signaling or physical layer signaling.

According to a third aspect of the present disclosure, the present disclosure further provides a terminal, which includes: the channel detection device of the LTE system in the unlicensed frequency band according to any one of the above technical solutions.

According to the above technical solution, when the base station instructs the terminal to perform the channel detection, the situation of uplink multi-user multiplexing can be considered, and the terminal can be further instructed to perform the reasonable channel detection process. Moreover, on the premise that the frequency spectrum utilization efficiency is improved, the coexistence with other systems is realized in the unlicensed frequency band, thereby ensuring the fairness between competing channels in the unlicensed frequency band at the same time.

### BRIEF DESCRIPTION OF THE DRAWINGS

FIG. 1A shows a schematic diagram of a self-scheduling terminal of a base station;

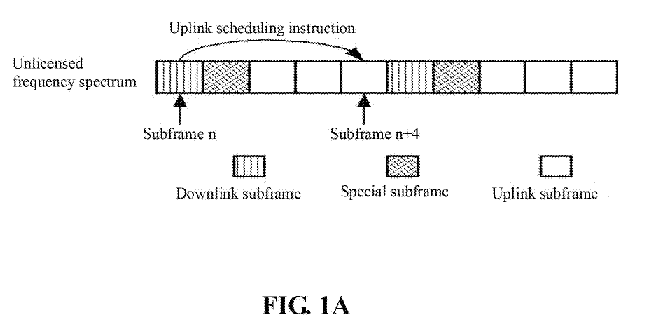

FIG. 1B shows a schematic diagram of a cross-carrier scheduling terminal of the base station;

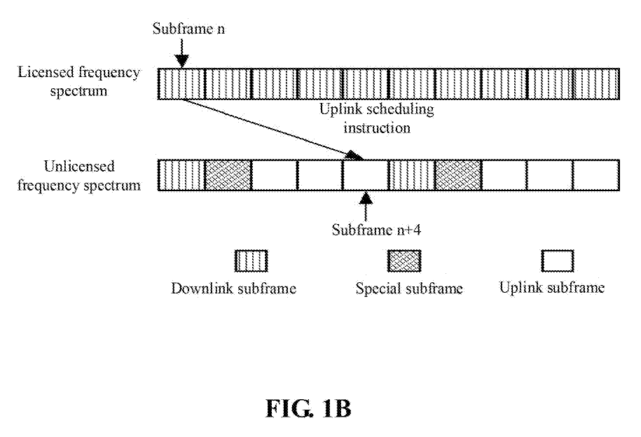

FIG. 2 shows a schematic flow diagram of a channel detection method of a Long Term Evolution (LTE) system in an unlicensed frequency band according to an embodiment of the present disclosure;

FIG. 3 shows a schematic structural diagram of the channel detection device of the LTE system in the unlicensed frequency band according to the embodiment of the present disclosure;

FIG. 4 shows a schematic structural diagram of a terminal according to the embodiment of the present disclosure;

FIG. 5 shows a schematic diagram of a Clear Channel Assessment (CCA) detection position of the base station when the cross-carrier scheduling terminal is scheduled according to the embodiment of the present disclosure;

FIG. 6 shows a schematic diagram of a CCA detection position of the base station when the cross-carrier scheduling terminal is scheduled according to another embodiment of the present disclosure;

FIG. 7 shows a schematic diagram of the adjustment method of the CCA threshold value according to the embodiment of the present disclosure;

FIG. 8 shows a schematic structural diagram of another terminal according to the embodiment of the present disclosure.

### DETAILED DESCRIPTION

In order to more clearly understand above objects, features and advantages of the present disclosure, a further detailed description of the present disclosure is given below with reference to the accompanying drawings and the specific implementation modes. It should be noted that under the condition that no conflict exists, the embodiments of the present disclosure and the features in the embodiments can be combined with each other.

Many specific details are set forth in the following description to facilitate full understanding of the present disclosure, however, the present disclosure may also be implemented in other ways other than those described herein, the protection scope of the present disclosure is not limited by the specific embodiments disclosed below.

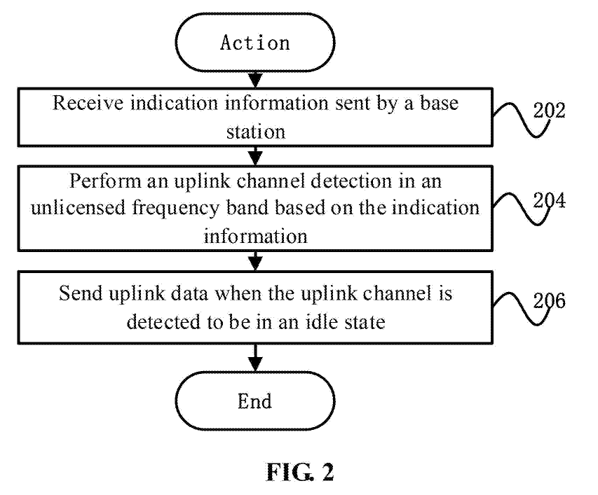

FIG. 2 shows a schematic flow diagram of a channel detection method of a Long Term Evolution (LTE) system in an unlicensed frequency band according to an embodiment of the present disclosure.

As shown in FIG. 2, the channel detection method of the LTE system in the unlicensed frequency band according to the embodiment of the present disclosure is provided and includes:

Step 202, receiving indication information sent by a base station;

Step 204, performing an uplink channel detection in an unlicensed frequency band based on the indication information;

Step 206, sending uplink data when the uplink channel is detected to be in an idle state.

In the technical solution, the uplink channel detection is performed in the unlicensed frequency band according to the indication information sent by the base station, thus, when the base station instructs the terminal to perform the channel detection, a situation of uplink multi-user multiplexing can be considered, and the terminal can be further instructed to perform a reasonable channel detection process. Moreover, on the premise that the frequency spectrum utilization efficiency is improved, the coexistence with other systems (such as a WI-FI system) is realized in an unlicensed frequency band, thereby ensuring the fairness between competing channels in an unlicensed frequency band at the same time.

In the above technical solution, optionally, the step of receiving indication information sent by the base station, and specifically includes: receiving parameter information of a channel detection performed by the terminal sent by the base station;

The step of performing the uplink channel detection in an unlicensed frequency band based on the indication information, and specifically includes: according to the parameter information, determining a position of a subframe that can be used for an uplink transmission, and monitoring an uplink scheduling instruction sent by the base station at the corresponding position of the subframe, when the uplink scheduling instruction is monitored, performing the uplink channel detection according to the parameter information.

In the technical solution, the base station can notify the terminal of the parameter information of the channel detection performed by the terminal in advance, the terminal determines the position of the subframe which can be used for uplink transmission according to the parameter information, and then the terminal can monitor whether the uplink scheduling instruction is sent by the base station at the corresponding position. When the uplink scheduling instruction is monitored, the terminal can perform the uplink channel detection according to the parameter information notified by the base station in advance. Specifically, after the base station notifies the terminal of the parameter information of performing the channel detection, the terminal considers that the subframe n+4 can be the position of the subframe, which can be used for uplink transmission based on the parameter information notified by the base station, it is further determined that the uplink scheduling instruction can be sent on the subframe n, and the terminal can monitor whether the uplink scheduling instruction sent by the base station is received on the subframe n, when received, the uplink channel detection can be performed on a subframe n+3.

In the above technical solution, optionally, the parameter information includes a combination of any one or more of the following: the position of the subframe that can be used for the uplink channel detection performed by the terminal, a symbol position that can be used for the uplink channel detection performed by the terminal, a period that can be used for the uplink channel detection performed by the terminal, and a Clear Channel Assessment (CCA) threshold value that can be used for the uplink channel detection performed by the terminal.

In any of the above technical solutions, optionally, the method further includes: monitoring the uplink scheduling instruction sent by the base station in a licensed frequency band and/or the unlicensed frequency band.

In any of the above technical solutions, optionally, the step of receiving the indication information sent by the base station specifically includes: monitoring the uplink scheduling instruction sent by the base station; and the step of performing the uplink channel detection in the unlicensed frequency band based on the indication information specifically includes: when the uplink scheduling instruction sent by the base station is monitored on any subframe, performing the uplink channel detection on a position corresponding to the any subframe.

In the technical solution, the base station does not need to notify the terminal of related information in advance, the terminal can continuously monitor the unlicensed frequency band or the licensed frequency band, to determine whether the uplink scheduling instruction sent by the base station is monitored. When the uplink scheduling instruction sent by the base station is monitored on any subframe, the terminal can perform the uplink channel detection on a corresponding position in the unlicensed frequency band. Specifically, if the terminal monitors the uplink scheduling instruction sent by the base station on the subframe n, the uplink scheduling instruction instructs the terminal to perform the uplink transmission on the subframe n+4, the terminal can perform the uplink channel detection on the subframe n+3.

In the above technical solution, optionally, the method further includes: determining a position corresponding to the any subframe based on a predefined rule, or

Receiving notification information sent by the base station, and determining the position corresponding to the any subframe according to the notification information.

In any of the above technical solutions, optionally, the step of receiving the indication information sent by the base station specifically includes: receiving an adjustment rule of the channel detection parameters sent by the base station;

The step of performing the uplink channel detection in the unlicensed frequency band based on the indication information specifically includes: adjusting the parameters of the terminal for performing the uplink channel detection every time according to the adjustment rule, and performing the uplink channel detection based on the adjusted parameters.

In the technical solution, the base station can notify the adjustment rule of the uplink channel detection parameters of the terminal, and then the terminal can adjust the channel detection parameters every time when the uplink channel detection is performed. For example, when the channel detection is performed every time, the threshold value of the channel detection can be adjusted every time.

In the above technical solution, optionally, the channel detection parameters include a combination of any one or more of the following: the CCA threshold value, the position of the subframe that can be used for the channel detection, the symbol position that can be used for the channel detection.

In any of the above technical solutions, optionally, the step of receiving the indication information sent by the base station specifically includes: receiving the indication information sent by the base station in the licensed frequency band or the unlicensed frequency band through wireless resource control signaling, media access control unit signaling or physical layer signaling.

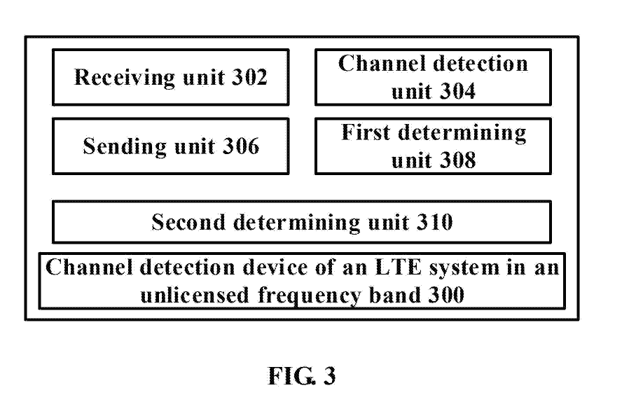

FIG. 3 shows a schematic structural diagram of the channel detection device of the LTE system in the unlicensed frequency band according to the embodiment of the present disclosure.

As shown in FIG. 3, according to the embodiment of the present disclosure, the channel detection device 300 of the LTE system in the unlicensed frequency band includes: a receiving unit 302, a channel detection unit 304 and a sending unit 306.

The receiving unit 302 configured to receive indication information sent by the base station;

The channel detection unit 304 is configured to perform the uplink channel detection in the unlicensed frequency band based on the indication information;

The sending unit 306 configured to send uplink data when the uplink channel is detected to be in the idle state by the channel detection unit.

In the technical solution, the uplink channel detection is performed in the unlicensed frequency band according to the indication information sent by the base station, thus, when the base station instructs the terminal to perform the channel detection, the situation of uplink multi-user multiplexing can be considered, and the terminal can be further instructed to perform the reasonable channel detection process. Moreover, on the premise that the frequency spectrum utilization efficiency is improved, the coexistence with other systems (such as the WI-FI system) is realized in the unlicensed frequency band, thereby ensuring the fairness between competing channels in the unlicensed frequency band at the same time.

In the above technical solution, optionally, the receiving unit 302 is specifically configured to: receive parameter information of the channel detection performed by the terminal sent by the base station; the channel detection unit 304 is specifically configured to: according to the parameter information, determine the position of the subframe which can be used for the uplink transmission, and monitor the uplink scheduling instruction sent by the base station at the corresponding position of the subframe, when the uplink scheduling instruction is monitored, perform the uplink channel detection according to the parameter information.

In the technical solution, the base station can notify the terminal of the parameter information of the channel detection performed by the terminal in advance, the terminal determines the position of the subframe which can be used for uplink transmission according to the parameter information, the terminal can then monitor whether the uplink scheduling instruction is sent by the base station at the corresponding position. When the uplink scheduling instruction is monitored, the terminal can perform the uplink channel detection according to the parameter information notified by the base station in advance.

Specifically, after the base station notifies the terminal of the parameter information of performing the channel detection, the terminal considers that the subframe n+4 can be the position of the subframe, which can be used for uplink transmission based on the parameter information notified by the base station, it is further determined that the uplink scheduling instruction can be sent on the subframe n, and the terminal can monitor whether the uplink scheduling instruction sent by the base station is received on the subframe n, when received, the uplink channel detection can be performed on the subframe n+3.

In the above technical solution, optionally, the parameter information includes the combination of any one or more of the following: the position of the subframe that can be used for the uplink channel detection performed by the terminal, the symbol position that can be used for the uplink channel detection performed by the terminal, the period that can be used for the uplink channel detection performed by the terminal, and the CCA threshold value that can be used for the uplink channel detection performed by the terminal.

In any of the above technical solutions, optionally, the channel detection unit 304 monitors the uplink scheduling instruction sent by the base station in the licensed frequency band and/or the unlicensed frequency band.

In any of the above technical solutions, optionally, the receiving unit 302 is specifically configured to: monitor the uplink scheduling instruction sent by the base station; the channel detection unit 304 is specifically configured to: when the uplink scheduling instruction sent by the base station is monitored by the receiving unit 302 on any subframe, perform the uplink channel detection on the position corresponding to the any subframe.

In the technical solution, the base station does not need to notify the terminal of related information in advance, the terminal can continuously monitor the unlicensed frequency band or the licensed frequency band, to determine whether the uplink scheduling instruction sent by the base station is monitored. When the uplink scheduling instruction sent by the base station is monitored on any subframe, the terminal can perform the uplink channel detection on the corresponding position in the unlicensed frequency band. Specifically, if the terminal monitors the uplink scheduling instruction sent by the base station on the subframe n, the uplink scheduling instruction instructs the terminal to perform the uplink transmission on the subframe n+4, the terminal can perform the uplink channel detection on the subframe n+3.

In the above technical solution, optionally, the device further includes: a first determining unit 308 configured to determine the position corresponding to the any subframe based on the predefined rule; or a second determining unit 310 configured to receive the notification information sent by the base station, and determine the position corresponding to the any subframe according to the notification information.

In any of the above technical solutions, optionally, the receiving unit 302 is specifically configured to: receive the adjustment rule of the channel detection parameters sent by the base station; the channel detection unit 304 is specifically configured to: adjust the parameters of the terminal for performing the uplink channel detection every time according to the adjustment rule, and perform the uplink channel detection based on the adjusted parameters.

In the technical solution, the base station can notify the adjustment rule of the uplink channel detection parameters of the terminal, and then the terminal can adjust the channel detection parameters every time when the uplink channel detection is performed. For example, when the channel detection is performed every time, the threshold value of the channel detection can be adjusted every time.

In the above technical solution, optionally, the channel detection parameters include a combination of any one or more of the following: the CCA threshold value, the position of the subframe that can be used for the channel detection, the symbol position that can be used for the channel detection, the period that can be used for the channel detection.

In any of the above technical solutions, optionally, the receiving unit 302 is specifically configured to: receive the indication information sent by the base station in the licensed frequency band or the unlicensed frequency band through wireless resource control signaling, media access control unit signaling or physical layer signaling.

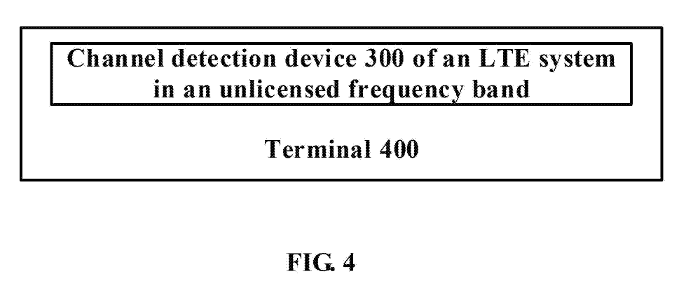

FIG. 4 shows a schematic structural diagram of a terminal according to the embodiment of the present disclosure.

As shown in FIG. 4, according to the embodiment of the present disclosure a terminal 400, which includes: the channel detection device 300 of the LTE system in the unlicensed frequency band shown in FIG. 3.

In conclusion, the technical solution of the present disclosure mainly provides an uplink Listening Before Talk (LBT) mechanism applied to the Licensed-Assisted Access (LAA) system, the coexistence with other systems can be realized under the condition that uplink multi-user multiplexing can be considered. Specifically, the present disclosure mainly provides three LBT schemes for uplink transmission, which are not only applicable to self-scheduling situations, particularly applicable to cross-carrier scheduling scenes. The three technical solutions provided by the present disclosure are described in detail below.

Scheme 1: Determining the Position of Uplink LBT Based on Base Station Indication

In the scheme, the base station notifies the terminal to perform the operation of uplink LBT at the corresponding position through Radio Resource Control (RRC) signaling, Media Access Control (MAC) Control Element (CE) signaling, or physical signaling in the licensed frequency band or the unlicensed frequency band. The notification information can include a period that can be used for the uplink LBT performed by the terminal, a position of the subframe, a symbol position of Orthogonal Frequency Division Multiplexing (OFDM), and the possible position of the subframe that can be used for the uplink transmission, the notification information can also include the CCA threshold value. The terminal performs the uplink LBT operation on the corresponding subframe position after receiving the configuration information. Meanwhile, the terminal monitors the uplink scheduling instruction only at a part of the position of the subframe.

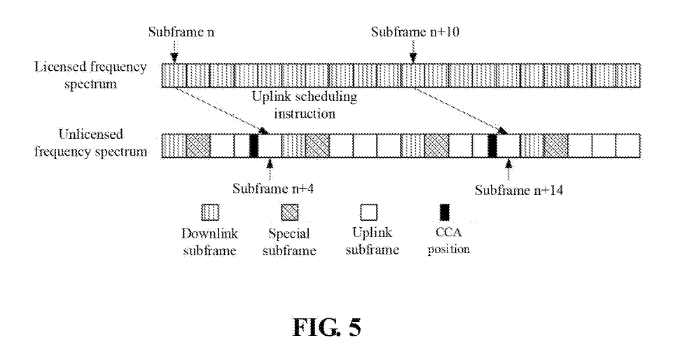

Specifically, as shown in FIG. 5, it is assumed that the base station notifies the terminal on the licensed frequency spectrum (surely, this may also be on the unlicensed frequency spectrum) that there is an uplink transmission subframe on the unlicensed frequency spectrum with a period of 10 ms through the RRC signaling, the MAC CE signaling, or physical signaling, for example, the uplink transmission opportunity exists on the subframe n+4 and the subframe n+14 in the figure, and CCA operation is performed on the last OFDM symbol on the subframe n+3 and the n+13. The terminal may then monitor the uplink scheduling instruction only on the subframe n and the subframe n+10 on the licensed frequency spectrum. When the uplink scheduling instruction sent by the base station is monitored, the terminal performs CCA operation on the subframe n+3 and the n+13. When the channel is detected to be idle, uplink data is transmitted on the subframe n+4 and the n+14.

It should be noted that FIG. 5 is only one example, and based on the same principle, the period of monitoring the uplink scheduling instruction by the terminal can be changed; the position of the subframe monitored in each period can also be changed; the monitored uplink scheduling instruction can be sent from the licensed frequency spectrum, and the monitored uplink scheduling instruction can also be sent from the unlicensed frequency spectrum; based on the notification of the base station, the position of the subframe serving as the CCA operation and the position of the OFDM symbol can also be changed.

Scheme 2: Determining the Position of Uplink LBT Based on Base Station Scheduling

In the scheme, the base station sends the uplink scheduling instruction on a certain subframe, and the terminal performs uplink LBT operation on the corresponding subframe position. In this scheme, the terminal may need to continuously monitor uplink scheduling information from the base station.

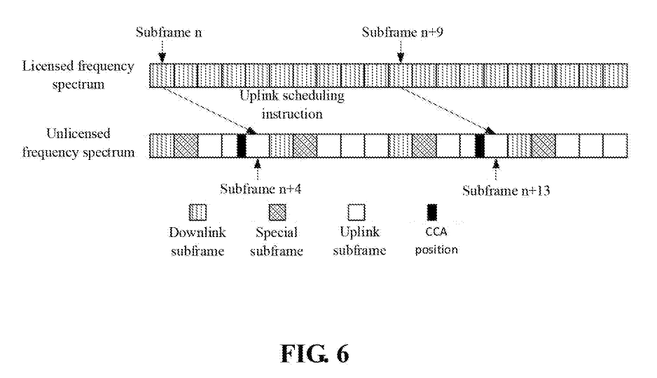

Specifically, as shown in FIG. 6, the terminal continuously monitors uplink scheduling information on the licensed frequency spectrum, and the uplink scheduling instruction sent by the base station is received on the subframe n and the subframe n+9 respectively, and indicates that the terminal can transmit uplink data on the subframe n+4 and the subframe n+13 respectively, then the terminal will perform CCA operation on the subframe n+3 and the n+12.

Similarly, the uplink scheduling instruction can also be sent from the unlicensed frequency spectrum, the terminal performs the CCA on the subframe position based on a rule (for example, the last symbol of the previous subframe of the uplink transmission subframe), or based on the position of the subframe notified by the base station.

Scheme 3: Rule-Based LBT

In the scheme, the base station notifies the terminal to perform LBT rules in the licensed frequency band or the unlicensed frequency band through the RRC signaling, the MAC CE signaling, or physical signaling, the rules may include the CCA threshold value, a CCA subframe position or an OFDM symbol position.

The following is illustrated with an example of adjusting the CCA threshold value: when the terminal performs uplink LBT operation, and the threshold values of different LBT operation points for judging whether the channels are idle are different. In addition, the base station notifies the terminal about threshold value adjustment rules through the RRC signaling, the MAC CE signaling, or physical signaling in the licensed frequency band or the unlicensed frequency band, or about a rule, which is adjusted by using a pre-defined threshold value is used.

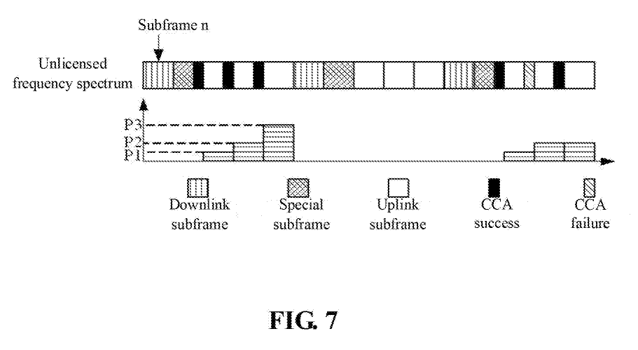

As shown in FIG. 7, it is assumed that the threshold value adjustment rules that the base station notifies the terminal through the RRC signaling, the MAC CE signaling, or physical signaling in the licensed frequency band or the unlicensed frequency band are: every time the CCA operation is completed, and the channel transmission data is successfully occupied, the threshold value of next CCA is increased by one time.

When the terminal performs the CCA threshold value on the last OFDM symbol of a subframe n+1, p1 is used, after successful(that is, the channel is detected to be idle), transmits data on a subframe n+2; the CCA threshold value used on the last symbol of the subframe n+2 on the basis of the notification rule is p2, and when the CCA detection is also successfully passed, the uplink data is transmitted on the subframe n+3; and the CCA threshold value used on the last symbol of the subframe n+3 on the basis of the notification rule is p3, and when the CCA detection is also successfully passed, the uplink data is transmitted on the subframe n+3. when the CCA fails (that is, the channel is detected to be busy), the CCA threshold value remains unchanged. Definitely, the notification rule can be other ways, and the terminal needs to determine a specific manner of CCA according to the notification rule.

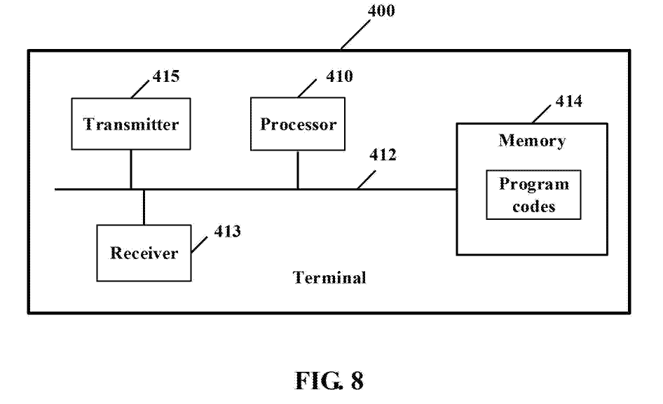

FIG. 8 is a schematic structural diagram of another terminal disclosed in the embodiment of the present disclosure. The terminal 400 in the embodiment of the present disclosure can be different types of electronic devices, such as a smart phone, a tablet computer, a palm computer, a mobile Internet device, a personal digital assistant, a media player, a smart television, a smart watch, smart glasses, a smart band, etc. As shown in FIG. 8, in an embodiment of the present disclosure, the terminal 400 includes at least one processor 410, such as a central processing unit (CPU), at least one receiver 413, at least one memory 414, at least one transmitter 415, and at least one communication bus 412. The communication bus 412 is used for realizing connection communications between these components. The receiver 413 and the transmitter 415 may be wired transmission ports, and can also be wireless equipments, such as including an antenna device, which is used for implementing data communications with other equipments. The memory 414 may be a high-speed random-access memory (RAM) or a non-volatile memory, such as at least one magnetic disk storage.

The processor 410 can execute an operating system and various installed application programs, program codes of the terminal 400, etc., for example, each of the various units as mentioned above, which includes the receiving unit 302, the channel detection unit 304, the sending unit 306, the first determining unit 308, the second determining unit 310, etc.

The memory 414 stores program codes, and the processor 410 can invoke the program codes stored in the memory 414 to perform corresponding functions through the communication bus 412. For example, each of the various units in FIG. 3 (e.g., the receiving unit 302, the channel detection unit 304, the sending unit 306, the first determining unit 308, the second determining unit 310, etc.) is program codes stored in the memory 414 and executed by the processor 410, so as to perform the functions of each unit to realize the control of the channel detection.

In an embodiment of the present disclosure, the memory 414 stores a plurality of instructions, and the plurality of instructions are executed by the processor 410 to realize the channel detection method. Specifically, the processor 410 receives indication information sent by the base station; the processor 410 performs the uplink channel detection in the unlicensed frequency band based on the indication information; the processor 410 sends uplink data when the uplink channel is detected to be in the idle state.

In a further embodiment, the processor 410 receives parameter information of the channel detection performed by the terminal sent by the base station; the processor 410 determines the position of the subframe which can be used for the uplink transmission according to the parameter information, and monitors the uplink scheduling instruction sent by the base station at the corresponding position of the subframe, when the uplink scheduling instruction is monitored, the processor 410 performs the uplink channel detection according to the parameter information.

In a further embodiment, the parameter information includes a combination of any one or more of the following: the position of the subframe that can be used for the uplink channel detection performed by the terminal, the symbol position that can be used for the uplink channel detection performed by the terminal, the period that can be used for the uplink channel detection performed by the terminal, and the CCA threshold value that can be used for the uplink channel detection performed by the terminal.

In a further embodiment, the processor 410 monitors the uplink scheduling instruction sent by the base station in the licensed frequency band and/or the unlicensed frequency band.

In a further embodiment, the processor 410 monitors the uplink scheduling instruction sent by the base station; when the uplink scheduling instruction sent by the base station is monitored on any subframe, the processor 410 performs the uplink channel detection on the position corresponding to the any subframe.

In a further embodiment, the processor 410 determines the position corresponding to the any subframe based on the predefined rule, or receives the notification information sent by the base station, and determines the position corresponding to the any subframe according to the notification information.

In a further embodiment, the processor 410 receives the adjustment rule of the channel detection parameters sent by the base station; adjusts the parameters of the terminal for performing the uplink channel detection every time according to the adjustment rule, and performs the uplink channel detection based on the adjusted parameters.

In a further embodiment, the channel detection parameters include a combination of any one or more of the following: the CCA threshold value, the position of the subframe that can be used for the channel detection, the symbol position that can be used for the channel detection, and the period that can be used for the channel detection.

In a further embodiment, the processor 410 receives the indication information sent by the base station in the licensed frequency band or the unlicensed frequency band through wireless resource control signaling, media access control unit signaling or physical layer signaling.

Specifically, specific implementation method of the instruction performed by the processor 410 can refer to the relevant steps in the corresponding embodiments of FIG. 2, and it is not repeated herein.

The above technical solution of the present disclosure mainly provides the uplink LBT mechanism applied to the LAA system, it allows the coexistence of LTE system and other systems in the unlicensed frequency band with the consideration of uplink multi-user multiplexing.

The technical solution of the present disclosure is described in detail with reference to the accompanying drawings, the present disclosure provides a channel detection solution of a new LTE system when the new LTE system works in an unlicensed frequency band, thus the terminal can perform a reasonable channel detection process, on the premise that the frequency spectrum utilization efficiency is improved, the coexistence with other systems in an unlicensed frequency band is realized, and thereby ensuring the fairness of competing channels in an unlicensed frequency band at the same time.

The above mentioned descriptions are merely preferred embodiments of the present disclosure, and are not to limit the present disclosure. For persons skilled in the art, various changes or modifications may be made to the present disclosure. Any modification, equivalent, and improvement without departing from the spirit and scope of the present disclosure, should be within the protection scope of the present disclosure.

We claim:

1. A channel detection method of a Long Term Evolution (LTE) system in an unlicensed frequency band, comprising:
receiving indication information sent by a base station;
performing an uplink channel detection in the unlicensed frequency band based on the indication information; and
sending uplink data when the uplink channel is detected to be in an idle state.

2. The channel detection method of the LTE system in the unlicensed frequency band of claim 1, wherein receiving indication information sent by the base station comprises:
receiving parameter information of a channel detection performed by a terminal sent by the base station; and
wherein performing the uplink channel detection in the unlicensed frequency band based on the indication information comprises:
according to the parameter information, determining a position of a subframe that can be used for an uplink transmission, and monitoring an uplink scheduling instruction sent by the base station at the corresponding position of the subframe, performing the uplink channel detection according to the parameter information when the uplink scheduling instruction is monitored.

3. The channel detection method of the LTE system in the unlicensed frequency band of claim 2, the parameter information comprises a combination of any one or more of:
the position of the subframe that can be used for the uplink channel detection performed by the terminal;
a symbol position that can be used for the uplink channel detection performed by the terminal;
a period that can be used for the uplink channel detection performed by the terminal; and
a Clear Channel Assessment (CCA) threshold value that can be used for the uplink channel detection performed by the terminal.

4. The channel detection method of the LTE system in the unlicensed frequency band of claim 2, further comprising:
monitoring the uplink scheduling instruction sent by the base station in a licensed frequency band or the unlicensed frequency band.

5. The channel detection method of the LTE system in the unlicensed frequency band of claim 1, wherein receiving the indication information sent by the base station comprises:
monitoring the uplink scheduling instruction sent by the base station;
wherein performing the uplink channel detection in the unlicensed frequency band based on the indication information comprises:
when the uplink scheduling instruction sent by the base station is monitored on any subframe, performing the uplink channel detection on a position corresponding to the any subframe.

6. The channel detection method of the LTE system in the unlicensed frequency band of claim 5, further comprising:
determining a position corresponding to the any subframe based on a predefined rule; or
receiving notification information sent by the base station, and determining the position corresponding to the any subframe according to the notification information.

7. The channel detection method of the LTE system in the unlicensed frequency band of claim 1, wherein receiving the indication information sent by the base station comprising:
receiving an adjustment rule of the channel detection parameters sent by the base station;
wherein performing the uplink channel detection in the unlicensed frequency band based on the indication information comprising:
adjusting the parameters of the terminal for performing the uplink channel detection every time according to the adjustment rule, and performing the uplink channel detection based on the adjusted parameters.

8. The channel detection method of the LTE system in the unlicensed frequency band of claim 7, the channel detection parameters comprise a combination of any one or more of:
the CCA threshold value, the position of the subframe that can be used for the channel detection, the symbol position that can be used for the channel detection.

9. The channel detection method of the LTE system in the unlicensed frequency band of claim 1, wherein receiving the indication information sent by the base station comprising:
receiving the indication information sent by the base station in the licensed frequency band or the unlicensed frequency band through wireless resource control signaling, media access control unit signaling or physical layer signaling.

10. A terminal, comprising:
at least one processor; and
a storage device storing a plurality of instructions, which when executed by the processor, causes the at least one processor to:
receive indication information sent by the base station;
perform the uplink channel detection in the unlicensed frequency band based on the indication information; and
send uplink data when the uplink channel is detected to be in the idle state by the channel detection unit.

11. The terminal of claim 10, wherein the at least one processor further:
receives parameter information of a channel detection performed by a terminal sent by the base station; and
wherein the at least one processor further:
according to the parameter information, determines a position of a subframe that can be used for an uplink transmission, and monitors an uplink scheduling instruction sent by the base station at the corresponding position of the subframe, performs the uplink channel detection according to the parameter information when the uplink scheduling instruction is monitored.

12. The terminal of claim 11, the parameter information comprises a combination of any one or more of:
the position of the subframe that can be used for the uplink channel detection performed by the terminal;
a symbol position that can be used for the uplink channel detection performed by the terminal;
a period that can be used for the uplink channel detection performed by the terminal; and
a Clear Channel Assessment (CCA) threshold value that can be used for the uplink channel detection performed by the terminal.

13. The terminal of claim 11, wherein the at least one processor further:
monitors the uplink scheduling instruction sent by the base station in a licensed frequency band or the unlicensed frequency band.

14. The terminal of claim 10, wherein the at least one processor further:
monitors the uplink scheduling instruction sent by the base station;
wherein the at least one processor further:
when the uplink scheduling instruction sent by the base station is monitored on any subframe, performs the uplink channel detection on a position corresponding to the any subframe.

15. The terminal of claim 14, wherein the at least one processor further:
determines a position corresponding to the any subframe based on a predefined rule; or
receives notification information sent by the base station, and determines the position corresponding to the any subframe according to the notification information.

16. The terminal of claim 10, wherein the at least one processor further:
receives an adjustment rule of the channel detection parameters sent by the base station;
wherein the at least one processor further:
adjusts the parameters of the terminal for performing the uplink channel detection every time according to the adjustment rule, and performs the uplink channel detection based on the adjusted parameters.

17. The terminal of claim 16, the channel detection parameters comprise a combination of any one or more of:
the CCA threshold value, the position of the subframe that can be used for the channel detection, the symbol position that can be used for the channel detection.

18. The terminal of claim 10, wherein the at least one processor further:
receives the indication information sent by the base station in the licensed frequency band or the unlicensed frequency band through wireless resource control signaling, media access control unit signaling or physical layer signaling.

19. (canceled)

20. A non-transitory storage medium having stored thereon instructions that, when executed by a processor of a terminal, causes the processor of the terminal to perform a channel detection method of a Long Term Evolution (LTE) system in an unlicensed frequency band, the channel detection method comprising:
receiving indication information sent by a base station;
performing an uplink channel detection in the unlicensed frequency band based on the indication information; and
sending uplink data when the uplink channel is detected to be in an idle state.

21. The non-transitory storage medium according to claim 20, wherein receiving indication information sent by the base station comprises:
receiving parameter information of a channel detection performed by a terminal sent by the base station; and
wherein performing the uplink channel detection in the unlicensed frequency band based on the indication information comprises:
according to the parameter information, determining a position of a subframe that can be used for an uplink transmission, and monitoring an uplink scheduling instruction sent by the base station at the corresponding position of the subframe, performing the uplink channel detection according to the parameter information when the uplink scheduling instruction is monitored.
